(19) United States
(12) Patent Application Publication
(10) Pub. No.: US 2026/0138687 A1
(43) Pub. Date: May 21, 2026

(54) CARGO STRUCTURE OF MOBILITY

(71) Applicants: Ajin Industrial Co., Ltd., Gyeongsan-si (KR); Hyundai Motor Company, Seoul (KR); Kia Corporation, Seoul (KR)

(72) Inventors: Kang Chul Lee, Hwaseong-si (KR); Do Hoi Kim, Hwaseong-si (KR); Yoon Sik Gu, Gyeongsan-si (KR)

(21) Appl. No.: 19/343,349

(22) Filed: Sep. 29, 2025

(30) Foreign Application Priority Data
Nov. 18, 2024 (KR) 10-2024-0164115

(51) Int. Cl. B62D 33/04; B60J 5/10; B62D 27/02; B62D 29/00

(52) U.S. Cl. CPC B62D 33/044; B60J 5/108; B62D 27/023; B62D 29/00

(57) ABSTRACT

A cargo structure of a mobility can include a cargo under body configured to be connected to a vehicle body, a cargo upper body connected to the cargo under body, and the cargo upper body includes hybrid members, wherein each of the hybrid members includes injection reinforcing material on an outer surface of a tubular part having a closed cross-section, wherein the hybrid members are disposed along a front-rear direction, a vehicle width direction, and a vertical direction of the vehicle body, a reinforcing unit connected to rear hybrid members of the hybrid members positioned at a rear of the cargo upper body, and a cargo door frame connected to the reinforcing unit along the front-rear direction and the vehicle width direction of the vehicle body.

### CROSS-REFERENCE TO RELATED APPLICATIONS

This application claims priority to and the benefit of Korean Patent Application No. 10-2024-0164115 filed with the Korean Intellectual Property Office on Nov. 18, 2024, the entire contents of which are incorporated herein by reference.

### TECHNICAL FIELD

The present disclosure relates to a cargo structure of a mobility.

### BACKGROUND

Recently, the vehicle industry has been introducing a new concept of future mobility vision for realizing a dynamic future city centered on humans. One of these future mobility solutions is the Purpose Built Vehicle (PBV) as a purpose-based mobility.

An example of a PBV is an electric vehicle (EV)-based environment-friendly mobility vehicle. These PBVs can provide various customized services to users. PBV can be configured in various forms depending on the type of customized service.

For example, the PBV can be used as a hailing type vehicle to transport occupants by configuring cabins in the front and rear of the vehicle body. In addition, the PBV can also be utilized as a cargo type vehicle (which those skilled in the art typically refer to as a delivery type) that has a cabin in the front part of the vehicle body and a cargo body assembly in the rear part of the vehicle body.

The cargo body assembly has an underbody and an upper body assembled to the underbody. The upper body mainly uses sandwich panels because of the ease of assembly.

A cargo door is mounted at the rear of the cargo body assembly to open and close the cargo room. The cargo door is mounted on a cargo door frame connected to the opening edge at the rear of the upper body.

The cargo door frame is placed at the rear opening edge of the upper body and is riveted to the sandwich panel of the upper body. The cargo door frame is riveted to the mount surface along the vehicle width direction at the rear opening edge of the upper body.

Because the cargo door frame, which is placed at the rear opening edge of the upper body, is simply connected to the sandwich panel of the upper body, sagging and torsional deformation of the cargo door may occur during operation of the vehicle.

The information contained in this background section is intended to promote understanding of the background of the present disclosure and may include matters that are not conventional art already publicly known, available, or in use.

### SUMMARY

The present disclosure relates to a cargo structure of a mobility, and more particularly, the present disclosure relates to a cargo structure of a mobility capable of securing strength of a cargo door frame.

An embodiment of the present disclosure can provide a cargo structure of mobility capable of securing the mounting strength of a cargo door and a cargo door frame.

A cargo structure of a mobility may include a cargo under body connected to the rear of a vehicle body, a cargo upper body connected to the cargo under body and in which hybrid members formed with injection reinforcing material on an outer surface of a tubular part having a closed cross-section are connected along the front-rear direction of the vehicle, the vehicle width direction, and the vertical direction, a reinforcing unit connected to rear hybrid members positioned at the rear of the cargo upper body, and a cargo door frame connected to the reinforcing unit along the front-rear direction of the vehicle and the vehicle width direction.

The hybrid members may be connected along the front-rear direction of the vehicle, the vehicle width direction, and the vertical direction through a plurality of joint members.

The reinforcing unit and the cargo door frame, which can be connected to each other, may form a closed cross-section connected to the closed cross-section of the tubular part.

The reinforcing unit may include a main roof reinforcement bracket connected to an upper surface portion of the rear roof hybrid member arranged along the vehicle width direction among the rear hybrid members, and a sub-roof reinforcement bracket connected to a rear surface portion of the rear roof hybrid member.

The main roof reinforcement bracket and the sub-roof reinforcement bracket may engage with the tubular part of the rear roof hybrid member.

The cargo door frame may include side frames arranged along the vertical direction on both sides along the vehicle width direction, and an upper frame connected along the vehicle width direction to an upper portion of the side frames.

An upper surface portion of the upper frame may engage along the vertical direction with the main roof reinforcement bracket, a roof outer plate connected to the cargo upper body, and the rear roof hybrid member.

A forward surface portion of the upper frame may engage the sub-roof reinforcement bracket and the rear roof hybrid member along the front-rear direction of the vehicle.

The sub-roof reinforcement bracket may include a sub-roof reinforcing flange part matching a forward surface portion of the upper frame.

The reinforcing unit may include a main side reinforcement bracket connected to an outer side part of rear pillar hybrid members arranged on both sides along the vehicle width direction among the rear hybrid members, and sub-side reinforcement brackets connected to a rear surface portion of the rear pillar hybrid members.

The main side reinforcement bracket and the sub-side reinforcement brackets may engage the tubular part of the rear pillar hybrid members.

The sub-side reinforcement brackets may include an overlap portion that overlaps a portion of the main side reinforcement bracket.

The outer side part of the side frames may engage along the vehicle width direction with the main side reinforcement bracket, a side outer plate connected to the cargo upper body, and the rear pillar hybrid members.

A forward surface portion of the side frames may engage with the sub-side reinforcement brackets and the rear pillar hybrid members along the front-rear direction of the vehicle.

The sub-side reinforcement brackets may include a sub-side reinforcing flange part matching a forward surface portion of the side frames.

The main side reinforcement bracket, the sub-side reinforcement brackets, and the side frames may form a closed cross-section connected to the closed cross-section of the tubular part.

For a cargo structure of a mobility according to an embodiment of the present disclosure, the binding strength of the cargo door frame can be secured, and the load of the cargo door frame can be easily dispersed.

Advantages that can be obtained or expected due to an embodiment are directly or implicitly disclosed in the detailed description of the disclosed example embodiments of the present disclosure. That is, various advantages predicted according to the disclosed example embodiments of the present disclosure will be disclosed in the detailed description that follows.

### BRIEF DESCRIPTION OF THE DRAWINGS

These drawings are intended for reference in explaining example embodiments of the present disclosure, and therefore, the technical ideas of the present disclosure are not necessarily limited to the accompanying drawings.

FIG. 1 is a side view illustrating a cargo body assembly of a mobility according to a disclosed example embodiment of the present disclosure.

FIG. 2 is a perspective view illustrating a cargo structure of a mobility according to a disclosed example embodiment of the present disclosure.

FIG. 3 is a partially exploded perspective view illustrating a cargo structure of a mobility according to a disclosed example embodiment of the present disclosure.

FIG. 4 is a partially exploded perspective view illustrating a cargo structure of a mobility according to a disclosed example embodiment of the present disclosure.

FIG. 5 is a cross-sectional view illustrating a hybrid member applied to a cargo structure of a mobility according to a disclosed example embodiment of the present disclosure.

FIG. 6 is a perspective view illustrating a reinforcing unit applied to a cargo structure of a mobility according to a disclosed example embodiment of the present disclosure.

FIG. 7 is an exploded perspective view illustrating a reinforcing unit applied to a cargo structure of a mobility according to a disclosed example embodiment of the present disclosure.

FIG. 8 is a perspective view illustrating a cargo door frame applied to a cargo structure of a mobility according to a disclosed example embodiment of the present disclosure.

FIG. 9 is a cross-sectional view along line A-A of FIG. 2.

FIG. 10 is a cross-sectional view along line B-B of FIG. 2.

The drawings referenced above are not necessarily to scale, and can be understood as presenting rather simplified representations of various features illustrating principles of the present disclosure. For example, certain design features of an example embodiment of the present disclosure, including particular dimensions, direction, position, and shape, can be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice an embodiment of the present disclosure. As those skilled in the art can realize, the described example embodiments may be modified in various different ways, without departing from the spirit or scopes of the present disclosure.

Terminology used herein is for the purpose of describing particular example embodiments and is not intended to necessarily limit the present disclosure. As used herein, singular forms can be intended to include the plural forms as well, unless the context clearly indicates otherwise.

It can be understood that the terms “comprise” and/or “include” as used herein indicate the presence of stated features, integers, steps, operations, elements, and/or components, but do not preclude the presence or addition of one or more other features, integers, steps, operations, components, and/or groups thereof.

As used herein, the term “and/or” includes any and all combinations of one or more of the associated listed items.

In this specification, the term “connected” can indicate a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive” or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, example embodiments of the present disclosure will be described in detail with reference to the attached drawings.

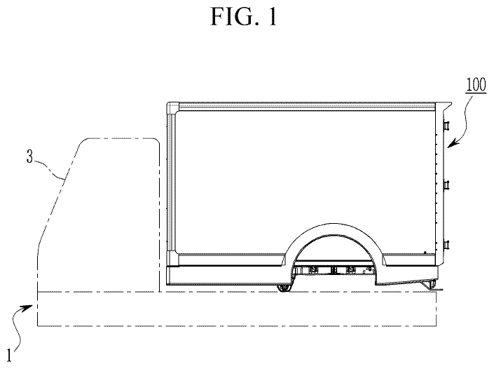

FIG. 1 is a side view illustrating a cargo body assembly of a mobility according to a disclosed example embodiment of the present disclosure.

Referring to FIG. 1, a cargo structure of the mobility according to a disclosed example embodiment of the present disclosure may be applied to, for example, a vehicle body 1 of a purpose-based mobility vehicle (hereinafter referred to as “PBV”).

The PBV may be utilized as an electric car-based life module vehicle that provides various customized services to users during the time it takes to move from the departure point to the destination.

The vehicle body 1 of the PBV may be manufactured in various shapes and sizes depending on the intended use of the PBV.

In this specification, the reference direction for describing the components described below may be set as the front-rear direction of the vehicle (e.g., the length direction or longitudinal direction of the vehicle), the vehicle width direction of the vehicle (e.g., the transverse direction), and the vehicle vertical direction (e.g., the height direction or up down direction).

In this specification, “upper end”, “upper portion”, or “upper surface” of a component can indicate an end, portion, or surface of a component that is relatively upper in the drawing, and “lower end”, “lower portion”, or “lower surface” of a component can indicate an end, portion, or surface of a component that is relatively lower in the drawing.

In this specification, an end of a component (e.g., one end or another (other) end, etc.) can denote an end of a component in any one direction, and an end portion of the component (e.g., one end portion) or other (another) end portion, etc.) can denote a portion of a component that includes that end.

The vehicle body 1 of the PBV can include, in one example, a front cabin 3 of a cab type configured in the front part.

A cargo structure body of a mobility 100 according to a disclosed example embodiment of the present disclosure can be mounted on the rear part of the vehicle body 1.

The PBV may be utilized as a cargo type or delivery type vehicle having a cargo room or luggage room formed in the rear part of the vehicle body 1 by a cargo structure of a mobility 100 according to a disclosed example embodiment of the present disclosure.

A cargo structure body of a mobility 100 according to a disclosed example embodiment of the present disclosure may be connected to a rear portion of the vehicle body 1 by a connecting unit.

The connecting unit here may be configured for various types of coupling, such as a configuration that is manually coupled with a mechanical configuration, a configuration that is coupled by the operation of a separate actuator, a configuration that can be coupled and/or released depending on the supply of external or internal power, including magnetic, etc. The configuration and operation of a “connecting unit”, can be used to combine or disassemble one or more modules or frames, etc., for example.

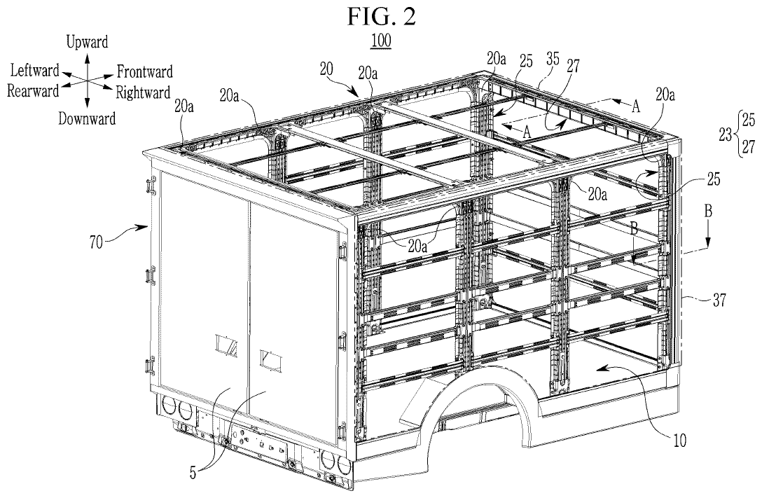

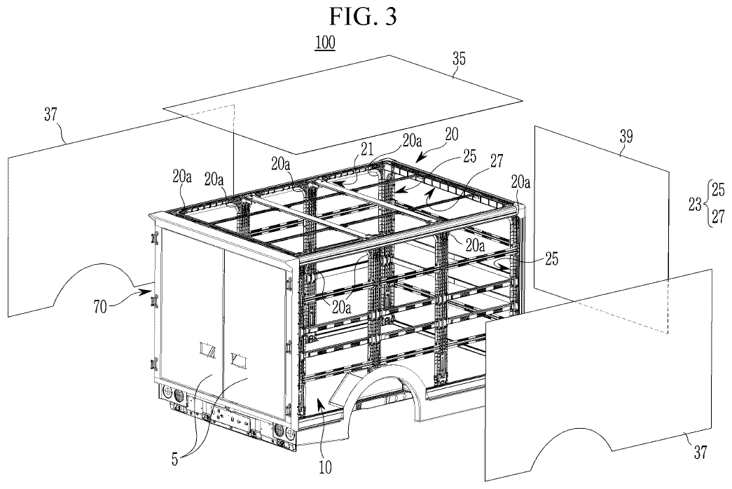

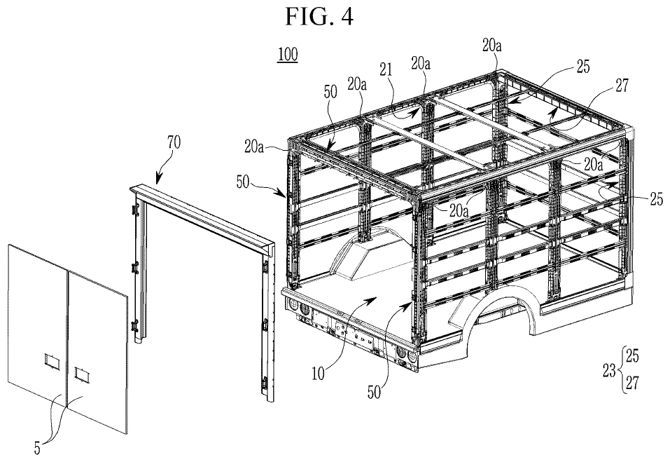

FIG. 2 is a perspective view illustrating a cargo structure of a mobility according to a disclosed example embodiment of the present disclosure. FIG. 3 is a partially exploded perspective view illustrating a cargo structure of a mobility according to a disclosed example embodiment of the present disclosure. FIG. 4 is a partially exploded perspective view illustrating a cargo structure of a mobility according to a disclosed example embodiment of the present disclosure.

Referring to FIG. 1 to FIG. 4, a cargo structure body of a mobility 100 according to a disclosed example embodiment of the present disclosure can provide a structure capable of securing the mounting strength of a cargo door 5 arranged at the rear to open and close a cargo room or a delivery room.

The cargo door 5 can be structured to be able to open and close the cargo room or delivery room in a hinged or hatchback type, for example, by door latches.

A cargo structure body of a mobility 100 according to a disclosed example embodiment of the present disclosure can include a cargo under body 10, a cargo upper body 20, a reinforcing unit 50, and a cargo door frame 70.

In a disclosed example embodiment of the present disclosure, a cargo under body 10 can be provided as a floor body of a cargo structure and can be connected to the rear portion of the vehicle body 1.

The cargo under body 10 may be connected to the rear part of the vehicle body 1 by the connecting unit.

In a disclosed example embodiment of the present disclosure, a cargo upper body 20 can be connected to both sides of the cargo under body 10 along the vehicle width direction to form a cargo room or a luggage room.

A cargo upper body 20 can include a plurality of hybrid members 21 connected along the front-rear direction of the vehicle, the vehicle width direction, and the vertical direction.

The hybrid members 21 may be connected along the front-rear direction of the vehicle, the vehicle width direction, and the vertical direction via a plurality of joint members 20a. The joint members 20a may, in one example, include aluminum extrusions.

The joint members 20a may connect the hybrid members 21 along the front-rear direction of the vehicle, the vehicle width direction, and the vertical direction through fastening members such as bolts, nuts, rivets, FDS, or any combination thereof.

Hereinafter, the hybrid members 21 positioned at the rear of the cargo upper body 20 among the hybrid members 21 are called rear hybrid members 23.

The rear hybrid members 23 may include rear pillar hybrid members 25 and rear roof hybrid members 27. The rear pillar hybrid members 25 can be connected along the vertical direction on both sides of the vehicle width direction of the cargo under body 10. The rear roof hybrid member 27 can be connected to the upper portion of the rear pillar hybrid members 25 along the vehicle width direction. The rear hybrid members 23 may be mounted with a cargo door 5.

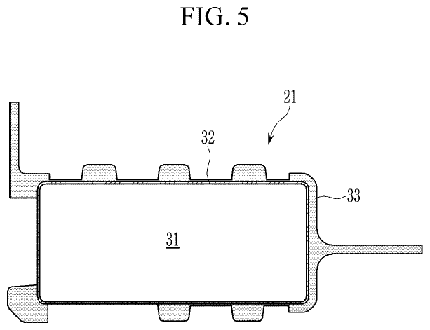

FIG. 5 is a cross-sectional view illustrating a hybrid member applied to a cargo structure of a mobility according to a disclosed example embodiment of the present disclosure.

Each of the hybrid members 21 may include a tubular part 32 of steel material having a closed cross-section 31, and an injection reinforcing material 33 of plastic material injection molded onto an outer surface of the tubular part 32 as shown in FIG. 5.

The hybrid members 21 of the cargo upper body 20 can be connected to roof outer plate 35, side outer plates 37, and front outer plate 39.

In a disclosed example embodiment of the present disclosure, a reinforcing unit 50 can be configured to reinforce the mounting strength of the cargo door frame 70, which will be described later. The reinforcing unit 50 can be connected to the rear hybrid members 23.

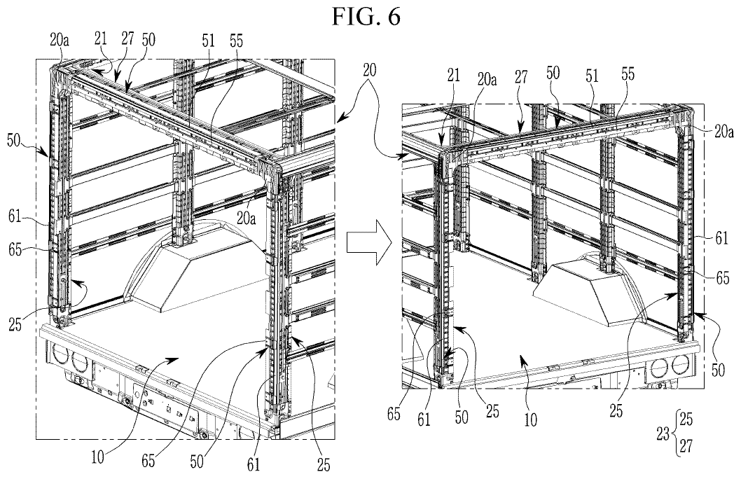

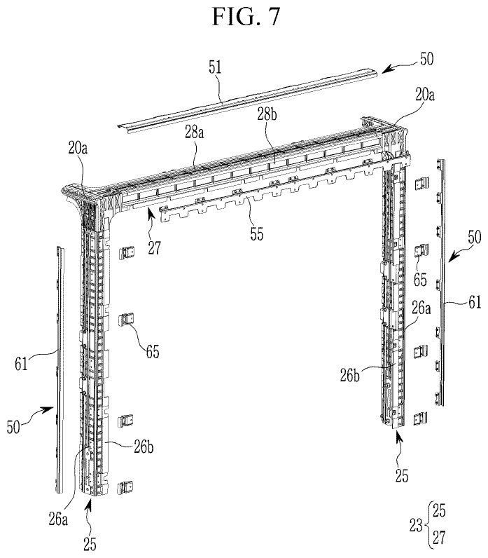

FIG. 6 is a perspective view illustrating a reinforcing unit applied to a cargo structure of a mobility according to a disclosed example embodiment of the present disclosure. FIG. 7 is an exploded perspective view illustrating a reinforcing unit applied to a cargo structure of a mobility according to a disclosed example embodiment of the present disclosure.

Referring to FIG. 6 and FIG. 7, a reinforcing unit 50 according to a disclosed example embodiment of the present disclosure can include a main roof reinforcement bracket 51, a sub-roof reinforcement bracket 55, a main side reinforcement bracket 61, and a plurality of sub-side reinforcement brackets 65.

The main roof reinforcement bracket 51 and sub-roof reinforcement bracket 55 can be connected to the rear roof hybrid member 27.

The main roof reinforcement bracket 51 can be a panel of steel material press-formed into a set, selected, or predetermined shape and can be connected to an upper surface portion 28a of the rear roof hybrid member 27.

The sub-roof reinforcement bracket 55 can be a panel of steel material press-formed into a set, selected, or predetermined shape and can be connected to a rear surface portion 28b of the rear roof hybrid member 27.

The main side reinforcement bracket 61 and the sub-side reinforcement brackets 65 can be connected to the rear pillar hybrid members 25.

The main side reinforcement bracket 61 can be a panel of steel material press-formed into a set, selected, or predetermined shape and can be connected to an outer side part 26a of the rear pillar hybrid members 25 along the vehicle width direction.

The sub-side reinforcement brackets 65 can be panels of steel material press-formed into a set, selected, or predetermined shape and can be connected to a rear surface portion 26b of the rear pillar hybrid members 25.

Referring to FIG. 2 to FIG. 4, in a disclosed example embodiment of the present disclosure, a cargo door frame 70 can be configured to mount a cargo door 5 to the rear hybrid members 23 of the cargo upper body 20.

The cargo door frame 70 can be connected to the reinforcing unit 50 along the front-rear direction of the vehicle and the vehicle width direction.

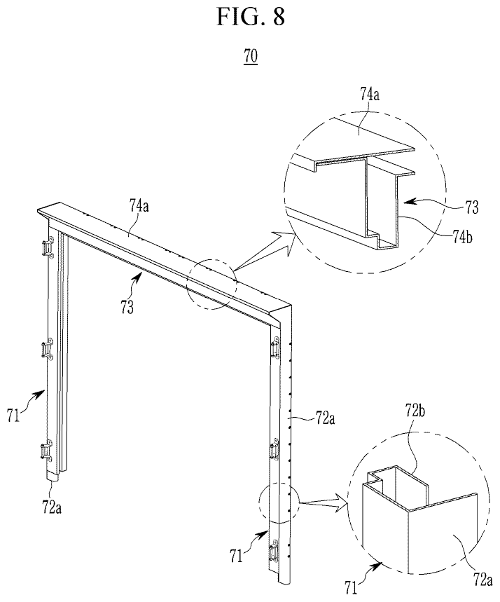

FIG. 8 is a perspective view illustrating a cargo door frame applied to a cargo structure of a mobility according to a disclosed example embodiment of the present disclosure.

The cargo door frame 70 can include side frames 71 and an upper frame 73, as shown in FIG. 8.

The side frames 71 can be arranged along the vertical direction on both sides according to the vehicle width direction and can be arranged at positions corresponding to the rear pillar hybrid members 25. Each of the side frames 71 can include an outer side part 72a and a forward surface portion 72b.

The upper frame 73 can be positioned at a position corresponding to the rear roof hybrid member 27 and can be connected to the upper portion of the side frames 71 along the vehicle width direction. The upper frame 73 can include an upper surface portion 74a and a forward surface portion 74b.

Hereinafter, the combined structure of the rear hybrid members 23, the reinforcing unit 50, and the cargo door frame 70 as described above will be described in detail with reference to the accompanying drawings.

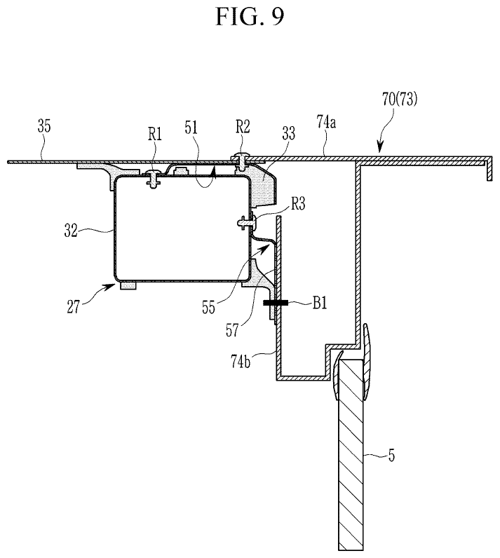

FIG. 9 is a cross-sectional view along line A-A of FIG. 2.

Referring to FIG. 7 and FIG. 9, in a disclosed example embodiment of the present disclosure, the main roof reinforcement bracket 51 can be engaged by adhesive and mechanical junction to the upper surface portion 28a of the rear roof hybrid member 27.

The main roof reinforcement bracket 51 can be bonded to the injection reinforcing material 33 of the rear roof hybrid member 27 by adhesive and engaged to the tubular part 32 of the rear roof hybrid member 27 by rivet R1.

The upper surface portion 74a of the upper frame 73 of the cargo door frame 70 can be engaged along the vertical direction with the main roof reinforcement bracket 51, the roof outer plate 35, and the upper surface portion 28a of the rear roof hybrid member 27 by rivet R2.

The sub-roof reinforcement bracket 55 can be engaged by adhesive and mechanical junction to the rear surface portion 28b of the rear roof hybrid member 27.

The sub-roof reinforcement bracket 55 can be bonded to the injection reinforcing material 33 of the rear roof hybrid member 27 by adhesive and engaged to the tubular part 32 of the rear roof hybrid member 27 by rivet R3.

The forward surface portion 74b of the upper frame 73 of the cargo door frame 70 can be engaged along the front-rear direction of the vehicle with the sub-roof reinforcement bracket 55 and the rear surface portion 28b of the rear roof hybrid member 27 by bolt B1.

The sub-roof reinforcement bracket 55 can match the forward surface portion 74b of the upper frame 73. The sub-roof reinforcement bracket 55 can include a sub-roof reinforcing flange part 57 that can match the forward surface portion 74b of the upper frame 73.

Accordingly, the upper frame 73 of the cargo door frame 70 may be mounted along the vertical direction to the upper surface portion 28a of the rear roof hybrid member 27 via the main roof reinforcement bracket 51. The upper frame 73 may be mounted along the front-rear direction of the vehicle to the rear surface portion 28b of the rear roof hybrid member 27 via the sub-roof reinforcement bracket 55.

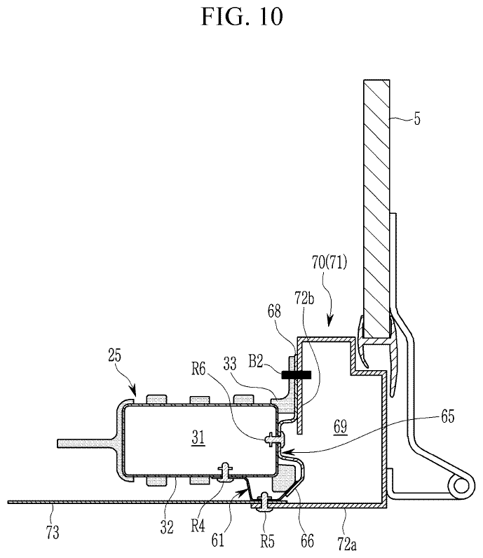

FIG. 10 is a cross-sectional view along line B-B of FIG. 2.

Referring to FIG. 7 and FIG. 10, in a disclosed example embodiment of the present disclosure, the main side reinforcement bracket 61 can be engaged by adhesive and mechanical junction to the outer side part 26a of the rear pillar hybrid members 25 along the vehicle width direction.

The main side reinforcement bracket 61 can be bonded to the injection reinforcing material 33 of the rear pillar hybrid members 25 by adhesive and engaged to the tubular part 32 of the rear pillar hybrid members 25 by rivet R4.

The outer side part 72a of the side frames 71 of the cargo door frame 70 can be engaged along the vehicle width direction with the main side reinforcement bracket 61, the side outer plates 37, and the outer side part 26a of the rear pillar hybrid members 25 by rivet R5.

The sub-side reinforcement brackets 65 can be engaged by adhesive and mechanical junction to the rear surface portion 26b of the rear pillar hybrid members 25.

The sub-side reinforcement brackets 65 can be bonded to the injection reinforcing material 33 of the rear pillar hybrid members 25 by adhesive and engaged to the tubular part 32 of the rear pillar hybrid members 25 by rivet R6.

The forward surface portion 72b of the side frames 71 of the cargo door frame 70 can be engaged along the front-rear direction of the vehicle with the sub-side reinforcement brackets 65 and the rear surface portion 26b of the rear pillar hybrid members 25 by bolt B2.

The sub-side reinforcement brackets 65 can be arranged to overlap a portion of the main side reinforcement bracket 61. Accordingly, the sub-side reinforcement brackets 65 can include an overlap portion 66 that overlaps a portion of the main side reinforcement bracket 61.

The sub-side reinforcement brackets 65 can match the forward surface portion 72b of the side frames 71. For this purpose, the sub-side reinforcement brackets 65 can include a sub-side reinforcing flange part 68 that matches the forward surface portion 72b of the side frames 71.

The main side reinforcement bracket 61, the sub-side reinforcement brackets 65, and the side frames 71 may form a closed cross-section 69 connected to the closed cross-section 31 of the tubular part 32 of the rear pillar hybrid members 25.

Accordingly, the side frames 71 of the cargo door frame 70 may be mounted along the vehicle width direction to the outer side part 26a of the rear pillar hybrid members 25 via the main side reinforcement bracket 61. The side frames 71 may be mounted along the front-rear direction of the vehicle to the rear surface portion 26b of the rear pillar hybrid members 25 via the sub-side reinforcement brackets 65.

The side frames 71 of the cargo door frame 70, which can be connected to the rear pillar hybrid members 25 through the main side reinforcement bracket 61 and the sub-side reinforcement brackets 65, may form double closed cross-sections 31 and 69.

For a cargo structure body of a mobility 100 according to a disclosed example embodiment of the present disclosure, the upper frame 73 of the cargo door frame 70 can be connected along the vertical direction to the upper surface portion 28a of the rear roof hybrid member 27 by the reinforcing unit 50.

The upper frame 73 of the cargo door frame 70 can be connected to the rear surface portion 28b of the rear roof hybrid member 27 along the front-rear direction of the vehicle by the reinforcing unit 50.

The side frames 71 of the cargo door frame 70 can be connected to the outer side part 26a of the rear pillar hybrid members 25 along the vehicle width direction by the reinforcing unit 50.

The side frames 71 of the cargo door frame 70 can be connected to the rear surface portion 26b of the rear pillar hybrid members 25 along the front-rear direction of the vehicle by the reinforcing unit 50.

Accordingly, a cargo structure body of a mobility 100 according to a disclosed example embodiment of the present disclosure may secure the bonding strength of the cargo door frame 70 by mounting the cargo door frame 70 to the rear hybrid members 23 of the cargo upper body 20 through the reinforcing unit 50.

A cargo structure body of a mobility 100 according to a disclosed example embodiment of the present disclosure may disperse the load of the cargo door frame 70 to the rear hybrid members 23 along the front-rear direction of the vehicle, the vehicle width direction, and the vertical direction.

And, for a cargo structure body of a mobility 100 according to a disclosed example embodiment of the present disclosure, the load of the cargo door 5 can be applied in a direction parallel to the rear pillar hybrid members 25 and can be transmitted to the cargo door frame 70 and the side outer plate 37.

A cargo structure body of a mobility 100 according to a disclosed example embodiment of the present disclosure can include double closed cross-sections 31 and 69 as described above, and can secure a mounting distance between a mounting point along the vehicle width direction of the cargo door frame 70 and a mounting point along the front-rear direction of the vehicle.

Accordingly, because the load of the cargo door frame 70 can be easily dispersed to the rear hybrid members 23, deformation of the cargo door frame 70 due to repeated opening and closing of the cargo door 5 can be prevented.

For a cargo structure body of a mobility 100 according to a disclosed example embodiment of the present disclosure, because the reinforcing unit 50 can be directly connected to the tubular part 32 of the rear hybrid members 23, the mounting reliability of the cargo door frame 70 can be secured.

The sub-side reinforcement brackets 65 can be engaged by adhesive and mechanical junction to the rear surface portion 26b of the rear pillar hybrid members 25.

The sub-side reinforcement brackets 65 can be bonded to the injection reinforcing material 33 of the rear pillar hybrid members 25 by adhesive and engaged to the tubular part 32 of the rear pillar hybrid members 25 by rivet R6.

The forward surface portion 72b of the side frames 71 of the cargo door frame 70 can be engaged along the front-rear direction of the vehicle with the sub-side reinforcement brackets 65 and the rear surface portion 26b of the rear pillar hybrid members 25 by bolt B2.

The sub-side reinforcement brackets 65 can be arranged to overlap a portion of the main side reinforcement bracket 61. Accordingly, the sub-side reinforcement brackets 65 can include an overlap portion 66 that can overlap a portion of the main side reinforcement bracket 61.

The sub-side reinforcement brackets 65 can match the forward surface portion 72b of the side frames 71. For this purpose, the sub-side reinforcement brackets 65 can include a sub-side reinforcing flange part 68 that can match the forward surface portion 72b of the side frames 71.

The main side reinforcement bracket 61, the sub-side reinforcement brackets 65, and the side frames 71 may form a closed cross-section 69 connected to the closed cross-section 31 of the tubular part 32 of the rear pillar hybrid members 25.

Accordingly, the side frames 71 of the cargo door frame 70 may be mounted along the vehicle width direction to the outer side part 26a of the rear pillar hybrid members 25 via the main side reinforcement bracket 61. The side frames 71 may be mounted along the front-rear direction of the vehicle to the rear surface portion 26b of the rear pillar hybrid members 25 via the sub-side reinforcement brackets 65.

The side frames 71 of the cargo door frame 70, which can be connected to the rear pillar hybrid members 25 through the main side reinforcement bracket 61 and the sub-side reinforcement brackets 65, may form double closed cross-sections 31 and 69.

For a cargo structure body of a mobility 100 according to a disclosed example embodiment of the present disclosure, the upper frame 73 of the cargo door frame 70 can be connected along the vertical direction to the upper surface portion 28a of the rear roof hybrid member 27 by the reinforcing unit 50.

The upper frame 73 of the cargo door frame 70 can be connected to the rear surface portion 28b of the rear roof hybrid member 27 along the front-rear direction of the vehicle by the reinforcing unit 50.

The side frames 71 of the cargo door frame 70 can be connected to the outer side part 26a of the rear pillar hybrid members 25 along the vehicle width direction by the reinforcing unit 50.

The side frames 71 of the cargo door frame 70 can be connected to the rear surface portion 26b of the rear pillar hybrid members 25 along the front-rear direction of the vehicle by the reinforcing unit 50.

Accordingly, a cargo structure body of a mobility 100 according to a disclosed example embodiment of the present disclosure may secure the bonding strength of the cargo door frame 70 by mounting the cargo door frame 70 to the rear hybrid members 23 of the cargo upper body 20 through the reinforcing unit 50.

A cargo structure body of a mobility 100 according to a disclosed example embodiment of the present disclosure may disperse the load of the cargo door frame 70 to the rear hybrid members 23 along the front-rear direction of the vehicle, the vehicle width direction, and the vertical direction.

For a cargo structure body of a mobility 100 according to a disclosed example embodiment of the present disclosure, the load of the cargo door 5 can be applied in a direction parallel to the rear pillar hybrid members 25 and can be transmitted to the cargo door frame 70 and the side outer plate 37.

A cargo structure body of a mobility 100 according to a disclosed example embodiment of the present disclosure can include double closed cross-sections 31 and 69 as described above, and can secure a mounting distance between a mounting point along the vehicle width direction of the cargo door frame 70 and a mounting point along the front-rear direction of the vehicle.

Accordingly, because the load of the cargo door frame 70 can be easily dispersed to the rear hybrid members 23, deformation of the cargo door frame 70 due to repeated opening and closing of the cargo door 5 can be prevented.

For a cargo structure body of a mobility 100 according to a disclosed example embodiment of the present disclosure, because the reinforcing unit 50 can be directly connected to the tubular part 32 of the rear hybrid members 23, the mounting reliability of the cargo door frame 70 can be secured.

While the present disclosure has been described in connection with what is presently considered to be practical example embodiments, it can be understood that the present disclosure is not necessarily limited to the disclosed embodiments. On the contrary, the present disclosure is intended to cover various modifications and equivalent arrangements included within the spirit and scopes of the appended claims.

What is claimed is:

1. A cargo structure of a mobility comprising:
a cargo under body configured to be connected to a vehicle body;
a cargo upper body connected to the cargo under body, and the cargo upper body comprises cargo-upper-body hybrid members, wherein each of the cargo-upper-body hybrid members includes injection reinforcing material on an outer surface of a tubular part having a closed cross-section, wherein the cargo-upper-body hybrid members are disposed along a front-rear direction, a vehicle width direction, and a vertical direction of the vehicle body;
a reinforcing unit connected to a rear hybrid member of the cargo-upper-body hybrid members positioned at a rear of the cargo upper body; and
a cargo door frame connected to the reinforcing unit along the front-rear direction and the vehicle width direction of the vehicle body.

2. The cargo structure of claim 1, wherein the cargo-upper-body hybrid members are connected to each other by a plurality of joint members.

3. The cargo structure of claim 1, wherein the reinforcing unit and the cargo door frame are connected to each other with a configuration to form a door-frame closed cross-section, and wherein the door-frame closed cross-section is connected to the closed cross-section of the tubular part of the rear hybrid member.

4. The cargo structure of claim 1, wherein the reinforcing unit comprises:
a main roof reinforcement bracket connected to an upper surface portion of the rear hybrid member, wherein the rear hybrid member is arranged along the vehicle width direction; and
a sub-roof reinforcement bracket connected to a rear surface portion of the rear hybrid member.

5. The cargo structure of claim 4, wherein the main roof reinforcement bracket and the sub-roof reinforcement bracket engage with the tubular part of the rear hybrid member.

6. The cargo structure of claim 4, wherein the cargo door frame comprises side frames arranged along the vertical direction on both sides along the vehicle width direction, and an upper frame connected along the vehicle width direction to an upper portion of the side frames; and
wherein an upper surface portion of the upper frame engages along the vertical direction with the main roof reinforcement bracket, a roof outer plate connected to the cargo upper body, and the rear hybrid member.

7. The cargo structure of claim 6, wherein a forward surface portion of the upper frame engages the sub-roof reinforcement bracket and the rear hybrid member along the front-rear direction of the vehicle body.

8. The cargo structure of claim 6, wherein the sub-roof reinforcement bracket comprises a sub-roof reinforcing flange part matching a forward surface portion of the upper frame.

9. The cargo structure of claim 1, wherein the reinforcing unit comprises:
a main side reinforcement bracket connected to an outer side part of rear pillar hybrid members of the cargo-upper-body hybrid members arranged on both sides along the vehicle width direction, wherein at least one of the rear pillar hybrid members is among the rear hybrid member; and
sub-side reinforcement brackets connected to a rear surface portion of the rear pillar hybrid members.

10. The cargo structure of claim 9, wherein the main side reinforcement bracket and the sub-side reinforcement brackets engage the tubular part of the rear pillar hybrid members.

11. The cargo structure of claim 9, wherein the sub-side reinforcement brackets comprise an overlap portion that overlaps a portion of the main side reinforcement bracket.

12. The cargo structure of claim 9, wherein the cargo door frame comprises side frames arranged along the vertical direction on both sides along the vehicle width direction, and an upper frame connected along the vehicle width direction to an upper portion of the side frames; and
wherein the outer side part of the side frames engages along the vehicle width direction with the main side reinforcement bracket, a side outer plate connected to the cargo upper body, and the rear pillar hybrid members.

13. The cargo structure of claim 12, wherein a forward surface portion of the side frames engages with the sub-side reinforcement brackets and the rear pillar hybrid members along the front-rear direction of the vehicle body.

14. The cargo structure of claim 12, wherein the sub-side reinforcement brackets comprise a sub-side reinforcing flange part matching a forward surface portion of the side frames.

15. The cargo structure of claim 12, wherein the main side reinforcement bracket, the sub-side reinforcement brackets, and the side frames form a side-frame closed cross-section connected to the closed cross-section of the tubular part of the rear pillar hybrid members.

16. The cargo structure of claim 4, wherein the reinforcing unit comprises:
a main side reinforcement bracket connected to an outer side part of rear pillar hybrid members of the cargo-upper-body hybrid members arranged on both sides along the vehicle width direction among the rear hybrid member; and
sub-side reinforcement brackets connected to a rear surface portion of the rear pillar hybrid members.

17. A cargo structure of a mobility comprising:
a cargo under body configured to be connected to a vehicle body;
a cargo upper body connected to the cargo under body, and the cargo upper body comprises cargo-upper-body hybrid members, wherein each of the cargo-upper-body hybrid members includes injection reinforcing material molded on an outer surface of a tubular metal part having a closed cross-section, wherein the cargo-upper-body hybrid members are disposed along a front-rear direction, a vehicle width direction, and a vertical direction of the vehicle body;
a reinforcing unit connected to first hybrid members of the cargo-upper-body hybrid members positioned at a first side of the cargo upper body; and
a cargo door frame connected to the reinforcing unit along the front-rear direction and the vehicle width direction of the vehicle body.

18. The cargo structure of claim 17, wherein the reinforcing unit comprises:
a main roof reinforcement bracket connected to an upper surface portion of a first roof hybrid member of the first hybrid members, wherein the first roof hybrid member is arranged along the vehicle width direction; and
a sub-roof reinforcement bracket connected to a first surface portion of the first roof hybrid member.

19. The cargo structure of claim 18, wherein the cargo door frame comprises side frames arranged along the vertical direction on both sides along the vehicle width direction, and an upper frame connected along the vehicle width direction to an upper portion of the side frames; and
wherein an upper surface portion of the upper frame engages along the vertical direction with the main roof reinforcement bracket, a roof outer plate connected to the cargo upper body, and the first roof hybrid member.

20. A purpose-based mobility comprising:
a vehicle body; and
a cargo structure removably connected to the vehicle body, wherein the cargo structure comprises:
a cargo under body connected to the vehicle body;
a cargo upper body connected to the cargo under body, and the cargo upper body comprises hybrid members, wherein each of the hybrid members includes injection reinforcing material on an outer surface of a tubular part having a closed cross-section, wherein the hybrid members are disposed along a front-rear direction, a vehicle width direction, and a vertical direction of the vehicle body;
a reinforcing unit connected to some of the hybrid members positioned at a rear of the cargo upper body; and
a cargo door frame connected to the reinforcing unit along the front-rear direction and the vehicle width direction of the vehicle body.
